(19) United States
(12) Patent Application Publication
(10) Pub. No.: US 2019/0344286 A1
(43) Pub. Date: Nov. 14, 2019

(54) Mechanical Screening System and Related Methods

(71) Applicant: Explorer Alive LLC, Tempe, AZ (US)

(72) Inventor: K. William Hindman, Tempe, AZ (US)

(21) Appl. No.: 15/978,462

(22) Filed: May 14, 2018

(51) Int. Cl. B03B 5/56; B07B 1/22

(52) U.S. Cl. CPC B03B 5/56; B07B 2201/04; B07B 1/22

(57) ABSTRACT

Implementations of mechanical screening systems may include a first trommel screen rotatably coupled within a second trommel screen, the second trommel screen including a first plurality of openings and a second plurality of openings, each opening of the first plurality of openings smaller than each opening of the second plurality of openings. The mechanical screening systems may also include an outer barrel coupled to the second trommel screen. The outer barrel may include a first slot opening and a second slot opening therein. The second trommel screen may be rotatable.

### BACKGROUND

### 1. Technical Field

Aspects of this document relate generally to mechanical screening systems, such as screening systems for screening raw material. More specific implementations involve trommel screening systems.

### 2. Background

Conventionally, mechanical screening systems screen material by passing it through a screen having various sized openings. Mechanical screening systems are used to size material and sort it as part of a separation process often employed in mining operations to assist with processing ore from bulk materials.

### SUMMARY

Implementations of mechanical screening systems may include a first trommel screen rotatably coupled within a second trommel screen, the second trommel screen including a first plurality of openings and a second plurality of openings, each opening of the first plurality of openings smaller than each opening of the second plurality of openings. The mechanical screening systems may also include an outer barrel coupled to the second trommel screen. The outer barrel may include a first slot opening and a second slot opening therein. The second trommel screen may be rotatable.

Implementations of mechanical screening systems may include one, all, or any of the following:

The first trommel screen may be configured to rotate in a direction opposite a direction the second trommel screen is configured to rotate.

The second trommel screen and the outer barrel may be configured to rotate synchronously with respect to each other.

The second trommel screen may include expanded metal.

A single motor may be configured to rotate the first trommel screen and the second trommel screen.

The screening system may be configured to sort material into three different ranges of size.

A width of the first slot opening may correspond to a width of each opening of the first plurality of openings.

A width of the second slot opening may correspond to a width of each opening of the second plurality of openings.

Implementations of mechanical screening systems may include a hopper coupled to a first trommel screen. The first trommel screen may be configured to rotate. The mechanical screening systems may also include a second trommel screen rotatably coupled around the first trommel screen. The second trommel screen may include a first plurality of openings and a second plurality of openings, each opening of the first plurality of openings smaller than each opening of the second plurality of openings. The mechanical screening system may also include one or more pressure washer lines coupled between the first trommel screen and the second trommel screen. The one or more pressure washer lines may include a plurality of nozzles directed at the first trommel screen. The first trommel screen may be configured to rotate in a first direction. The second trommel screen may be configured to rotate in a second direction.

Implementations of mechanical screening systems may include one, all, or any of the following:

The one or more pressure washer lines may not be configured to rotate.

The first trommel screen may include a plurality of openings facing the second trommel screen.

Each opening of the plurality of openings may be substantially identically shaped and substantially identically sized.

A width of each opening of the first trommel screen may be substantially equal to a width of each opening of the second plurality of openings of the second trommel screen.

The second trommel screen may include expanded metal.

The screening system may be configured to screen wet material and dry material.

The screening system may include a lifting mechanism configured to lift a first end of the mechanical screening system while the first trommel screen is rotating.

Implementations of mechanical screening systems may include a hopper coupled to a first trommel screen. The first trommel screen may be configured to rotate. The mechanical screening systems may include a second trommel screen rotatably coupled around the first trommel screen. The second trommel screen may include a first plurality of openings and a second plurality of openings. Each opening of the first plurality of openings may be smaller than each opening of the second plurality of openings. The mechanical screening systems may include an outer barrel rotatably coupled around the second trommel screen. The outer barrel may include a first and a second opening in a side thereof. The mechanical screening systems may also include a pressure washer line fixedly coupled between the first trommel screen and the second trommel screen, a lifting mechanism configured to lift a first end of the screening system while the first trommel screen rotates, a first motor coupled to and configured to rotate the first trommel screen in a first direction, and a second motor coupled to and configured to rotate the second trommel screen and the outer barrel in a second direction.

Implementations of mechanical screening systems may include one, all, or any of the following:

The second trommel screen may further include a third plurality of openings, and each opening of the third plurality of openings may be larger than each opening of the second plurality of openings.

The outer barrel may further include a third opening in the side thereof.

The mechanical screening system may include a first plate coupled between a first end of the outer barrel and a first end of the second trommel screen, and a second plate coupled between a second end of the outer barrel and a second end of the second trommel screen.

The lifting mechanism may be configured to lift the first end of the screening system 15 degrees.

The mechanical screening system may further include a protective box coupled over the first trommel screen, the second trommel screen, and the outer barrel.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and:

FIG. 1 is a side view of a mechanical screening system;

FIG. 2 is a top view of the mechanical screening system;

FIG. 3 is a cross-sectional side view of a screening portion of the mechanical screening system;

FIG. 4 is a side perspective view of a first trommel screen;

FIG. 5 is a side perspective view of a second trommel screen;

FIG. 6 is a side view of an outer barrel;

FIG. 7 is a perspective view of an end of a first trommel screen within a second trommel screen within an outer barrel;

FIG. 8 is a perspective view of a screening portion of a first implementation of a mechanical screening system;

FIG. 9 is a perspective view of a screening portion of a second implementation of a mechanical screening system;

FIG. 10 is a magnified perspective view of the first trommel screen roller support/bearing assembly of FIG. 9;

FIG. 11 is a perspective view of an implementation of a mechanical screening system; and

FIG. 12 is a see-through perspective view of a protective box covering a mechanical screening system.

### DESCRIPTION

This disclosure, its aspects and implementations, are not limited to the specific components, assembly procedures or method elements disclosed herein. Many additional components, assembly procedures and/or method elements known in the art consistent with the intended mechanical screening system will become apparent for use with particular implementations from this disclosure. Accordingly, for example, although particular implementations are disclosed, such implementations and implementing components may comprise any shape, size, style, type, model, version, measurement, concentration, material, quantity, method element, step, and/or the like as is known in the art for such mechanical screening systems, and implementing components and methods, consistent with the intended operation and methods.

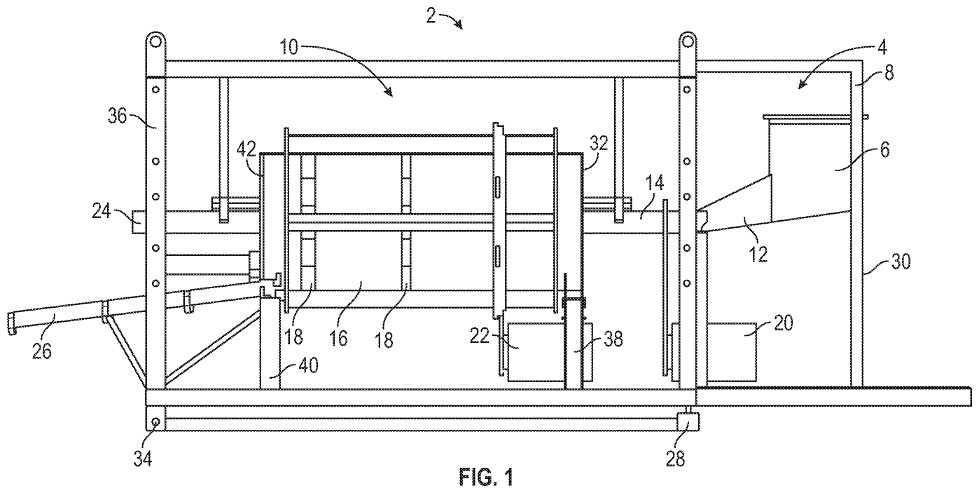

Referring to FIG. 1, a side view of a mechanical screening system is illustrated. In various implementations, the mechanical screening system 2 may include a hopper portion 4. The hopper portion 4 may include a hopper 6 or any other type of feeding mechanism used to transport or funnel material into a screening portion 10 of the mechanical screening system 2. The hopper 6 may be coupled to a frame 8 of the mechanical screening system 2. In other implementations, the hopper portion may be separate from the mechanical screening system. The mechanical screening system may be configured to screen raw material that may be wet or dry. Specifically, the mechanical screening system may be configured to screen rocks, ore, or minerals, organic material, and soil, including any type of soil (such as, by non-limiting example, clay, sand, gravel, silt, peat, chalk, and loam). In particular implementations, the mechanical screening system is configured to screen dredged material from the bottom of a body of water or waterway. In turn, such material may be pumped, dumped, or otherwise placed within the hopper portion 4. The hopper portion 4 may be configured to feed any such material into the screening portion 10 of the mechanical screening system 2. In particular implementations, and as illustrated by FIG. 1, the hopper 6 may feed the material into the screening portion through a chute 12 and into an inner pipe 14. In various implementations, the hopper portion 4 may control the rate the material is fed into the screening portion 10. In various implementations, the mechanical screening system, and the hopper, may be configured to accept and screen material having a diameter (largest length) as wide as 4 inches, 12 inches, 20 inches, or any other size greater than 4 inches or less than 20 inches.

The mechanical screening system includes a screening portion 10 coupled to the frame 8. In the implementations disclosed herein, the screening portion 10 includes one or more trommel screens, however, it is understood that various implementations disclosed herein may incorporate a screening portion including a type of screen in place of or in conjunction with the one or more trommel screens, such as, by non-limiting example, a grizzly screen, a vibrating screen, a roller screen, a curved screen, or any other type of screen. In implementations with more than a single trommel screen, the trommel screens may be within or encompass one another. In the implementation illustrated by FIG. 1, the inner pipe 14 may be a first trommel screen. In various implementations, the screening portion 10 may include an outer barrel 16 coupled around the one or more trommel screens. The outer barrel 16 may have one or more openings 18 configured to allow screened material to pass through.

The one or more trommel screens may be rotatable. In implementations with more than one trommel screen, the trommel screens may be configured to rotate in either the same or a different direction from one another, and may be powered by a single or multiple motors. As illustrated by FIG. 1, at least the inner pipe 14, or first trommel, is rotated through a first motor 20. In particular implementations, the first motor powers just the first trommel screen, however, in other implementations it may power the rotation of other trommel screens in either the same or opposing directions. In various implementations, the outer barrel 16 may also be rotatable. As illustrated by FIG. 1, the outer barrel 16 may be rotated by a second motor 22. In various implementations, the outer barrel 16 may be fixedly coupled to one or more of the one or more trommel screens. In such implementations, the one or more of the one or more trommel screens may rotate with the outer barrel 16. The first motor 20 and the second motor 22 may rotate their respective trommel screens and/or outer barrel using chains, belts, gears, or any other mechanism. In addition to the one or more trommel screens and/or outer barrel 16 being able to rotate in different directions, the one or more trommel screens and/or the outer barrel may rotate with varying speeds of rotation from one another. Similarly, the one or more trommel screens and/or the outer barrel may have varying phases of rotation from one another. Specifically, the one or more trommel screens and/or the outer barrel may rotate in a manner configured to result in a slumping motion, a cataracting motion, a centrifuging motion, or any other motion of the material to be screened.

Still referring to FIG. 1, the screening portion 10 of the mechanical screening system may be configured to output screened material through a variety of locations, including the one or more openings 18 of the outer barrel as well as an end 24 of the first trommel screen (or inner pipe 14). The screening portion 10 may be configured to output the screened material into, by non-limiting example, chutes (such as chute 26), sluice boxes, additional screening systems, or simply piles of the screened material. In various implementations, such chutes, sluice boxes, and/or additional screening systems may be part of or separate from the mechanical screening system 2.

As illustrated by FIG. 1, the mechanical screening system 2 may include a lifting mechanism 28. The lifting mechanism 28 may be configured to lift a first end 30 of the mechanical screening system. In other implementations, the lifting mechanism 28 may be configured to only lift a first end 32 of the screening portion 10 of the mechanical screening system 2. In implementations including the lifting mechanism, a portion of the frame 8 may include a hinge 34 near the second end 36 of the mechanical screening system 2 which allows for the first end 30 to be raised. In still other implementations, only the trommel screens and/or outer barrel 16 within the screening portion 10 may tilt without tilting the frame 8. In such implementations, either the barrel supports 38 at the intake end, or first end 32, of the screening portion 10 and/or the barrel supports 40 at the discharge end, or second end 42, of the screening portion may be raised and/or lowered to tilt the screening portion. In particular implementations, the lifting mechanism 28, or other mechanism used to raise and/or lower any barrel supports, may lift the first end 30 of the mechanical screening system, or first end 32 of the screening portion up to fifteen degrees relative to the second end 36 of the mechanical screening system. In other implementations, the mechanical screening system and/or the screening portion may be raised more than fifteen degrees. As illustrated by FIG. 1, the lifting mechanism is configured to lift the first end 32 of the screening portion 10 and the hinge 34 is located near the second end 42 of the screening portion, however, in other implementations, the hinge and the lifting mechanism may be switched so the lifting mechanism is configured to lower/raise the second end 42 of the screening portion 10 and the hinge 34 is located near the first end 32 of the screening portion 10.

In particular implementations, the same motor that powers the rotation of one or more of the trommel screens may also power the lifting mechanism 28. In other implementations, a motor separate from the motors that rotate one or more of the trommel screens and/or outer barrel 16 may power the lifting mechanism 28. In various implementations, the lifting mechanism may include or have components similar to a pneumatic jack, a screw jack, a scissor jack, or any other type of lifting mechanism. In various implementations, an individual may be able to manually raise/lower the mechanical screening system 2 through the lifting device 28 without using a motor. The lifting mechanism described herein may or may not be utilized with any implementation of a mechanical screening system disclosed herein.

In particular implementations, the lifting mechanism 28 may be configured to raise/lower the mechanical screening system 2 during operation, or while rotating the trommel screens, of the mechanical screening system 2. In such implementations, by raising/lowering the first end of the mechanical screening system 2, the rate of screening may be adjusted to maintain optimal processing of the system. In other implementations, the mechanical screening system may not be configured to raise/lower during operation, but rather the screening portion 10 and/or the mechanical screening system 2 may be raised and/or lowered prior to operation of the mechanical screening system 2.

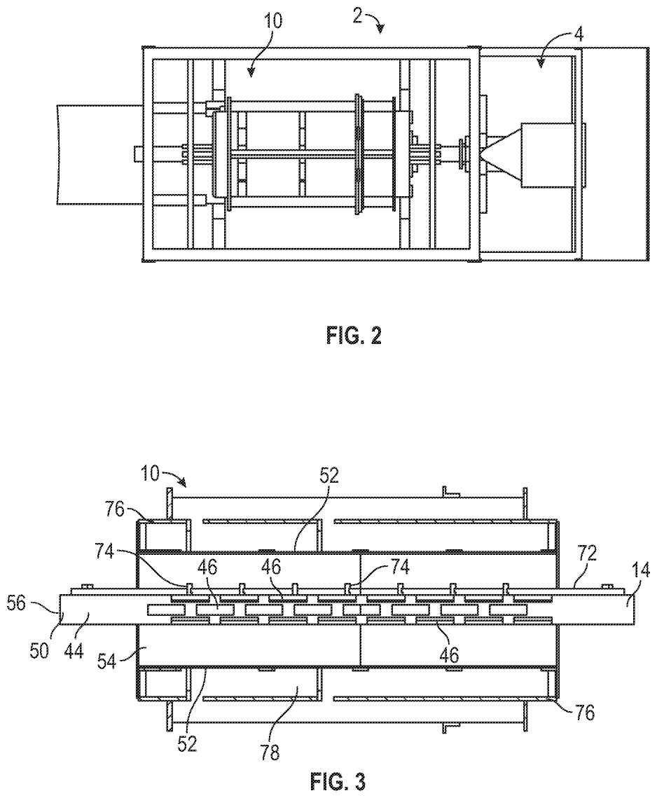

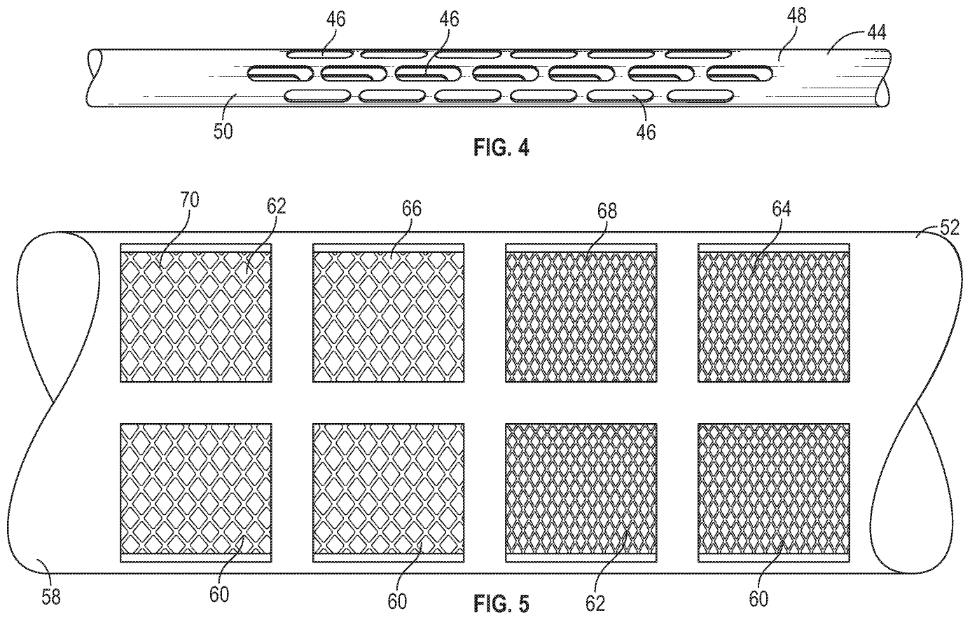

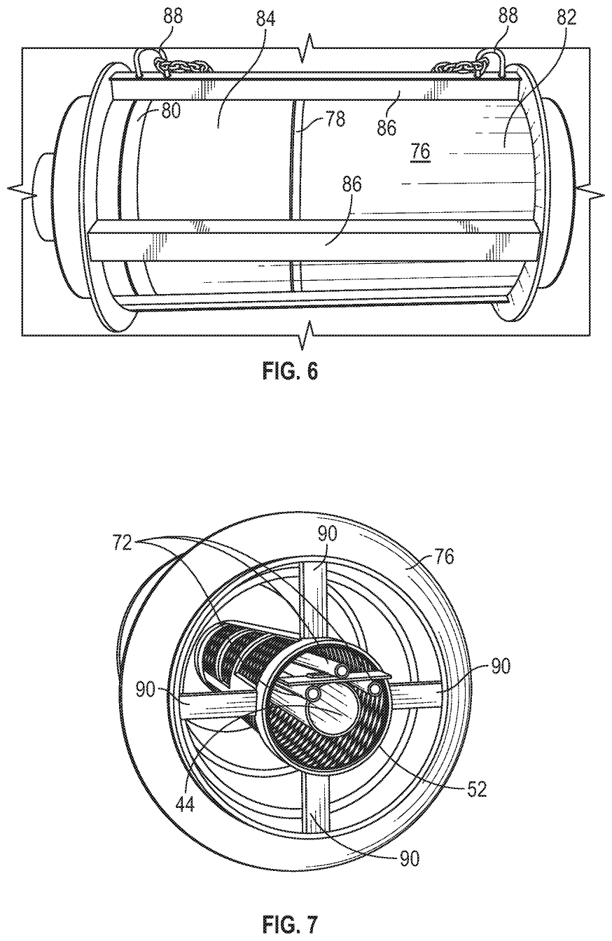

Referring to FIG. 2, a top view of a mechanical screening system of FIG. 1 is illustrated. As previously explained herein, the mechanical screening system 2 may include a hopper portion 4 and a screening portion 10. Referring to FIG. 3, a cross-sectional side view of the screening portion of the mechanical screening system of FIG. 1 is illustrated. As previously explained herein, the screening portion 10 may include an inner pipe 14 which may also be a first trommel screen 44. The area within the first trommel screen may be referred to as a first stage. In various implementations, the first trommel screen may have a diameter (largest length) of four inches, twelve inches, twenty inches, or any other size less than 20 inches or more than four inches. Referring to FIG. 4, a side perspective view of the first trommel screen 44 is illustrated. The first trommel screen includes a plurality of openings 46. In various implementations, such as the implementation illustrated by FIG. 4, the plurality of openings 46 may be perforations within the inner pipe 14. The inner pipe 14 may be formed of a metal or any other durable and rigid material. In other implementations, the plurality of openings 46 may be openings within a screen coupled within a pipe, similar to what is illustrated in FIG. 5. In such implementations, the first trommel screen may also include expanded metal. As illustrated by FIG. 4, the plurality of openings 46, which may include any number of openings, may all be substantially identically shaped and substantially identically sized. In other implementations, the size of the plurality of holes 46 may increase from a first end 48 of the first trommel screen 44, which corresponds to the first end 32 of the screening portion 10 illustrated in FIG. 1, to a second end 50 of the first trommel screen, which corresponds to the second end 42 of the screening portion 10 illustrated in FIG. 1. In particular implementations, the first trommel screen may include multiple sections of plurality of openings, with the openings within a particular section identically shaped and sized, but the different sections may include varying sizes and shapes of openings. In such implementations, the first trommel screen may include any number of sections. The openings within the plurality of openings 46 may be, by non-limiting example, a stadium shape, rectangular, ovate, or any other closed three-dimensional shape. A width of each opening may be less than a length of each opening. In particular implementations, the width of each opening is about one inch. In other implementations, the width may be the same as the length.

In various implementations, the inner surface of the first trommel screen 44 may include one or more ridges. The ridges may facilitate the breaking up of material as well as the transport of the material through the first trommel screen 44. In a particular implementation, the inner surface of the first trommel screen 44 may include one or more ridges that spiral down the length of the screen to facilitate movement of material through the screen. Referring back to FIG. 3, the second end 50 of first trommel screen may have an open end 56 that material too large to pass through the plurality of openings 46 may exit through. In various implementations, the first stage may be considered a de-rocker stage as the largest pieces of material are screened out of the end 56 of the first trommel screen 44.

In the implementations disclosed herein, and as previously explained, the first trommel screen is coupled to a motor. In particular implementations, such as the implementation illustrated by FIG. 1, a chain/belt may couple around a portion of the inner pipe 14, or first trommel screen, and a first motor may rotate the first trommel screen in any direction, speed, or phase disclosed herein. The portion of the inner pipe 14 may include a chain ring or another mechanism to allow the chain/belt to rotate the inner pipe 14.

Referring to FIG. 3, the screening portion 10 may include a second trommel screen 52. The first trommel screen 44 may be rotatably coupled within the second trommel screen 52. As the material exits the first stage, or the area within the first trommel, through the plurality of openings 46, it may fall into a second stage 54, or an area between the first trommel screen 44 and the second trommel screen 52. In various implementations, the diameter of the second trommel screen is larger than the diameter of the first trommel screen. Referring specifically to FIG. 5, a side perspective view of a second trommel screen is illustrated. In particular implementations, the second trommel screen 52 may include a pipe 58 with a plurality of large openings 60 therein. One or more screens 62 may be coupled to the pipe 58 in order to form the second trommel screen 52. In other implementations, the second trommel screen 52 may just include a pipe with a plurality of openings therein, similar to the first trommel screen illustrated in FIG. 4. In various implementations, including the implementation illustrated by FIG. 5, the second trommel screen 52 includes a first plurality of openings 64 and a second plurality of openings 66. In particular implementations, the first plurality of openings 64 may be included within a first screen 68 and the second plurality of openings 66 may all be included in a second screen 70. As illustrated by FIG. 5, the openings of the first plurality of openings 64 may be smaller than the openings of the second plurality of openings 66. While the implementation illustrated by FIG. 5 only illustrates two pluralities of openings, it is understood that other implementations may include 3, 4, 5, or any other number of plurality of openings in order to screen material into any given number of sizes. In such implementations, the pluralities of openings may be arranged according to size of the openings within the plurality of openings, and may be arranged from the smallest to the largest openings. In various implementations, a width of each opening in the second plurality of openings 66 may be substantially the same size as a width of the openings in the first plurality of openings 46 of the first trommel screen 44. In such implementations, material smaller in size than the openings in the first trommel screen 44 may fall onto the second trommel screen. Material that is smaller than the openings of the first plurality of openings 64 may pass through the openings, otherwise the material may be moved to the second plurality of openings, through which the material may pass. In implementations where the size of the first plurality of openings 46 of the first trommel screen 44 are substantially the same size as the second plurality of openings 66 of the second trommel screen 52, all the material that enters the second stage 54 may pass through either the first plurality of openings 64 or the second plurality of openings 66. In particular implementations, each opening of the first plurality of openings 64 may be about ⅜ of an inch wide, however, in other implementations, each opening of the first plurality of openings 64 may be more or less than about ⅜ of an inch wide. In particular implementations, each opening of the second plurality of openings 66 may be about an inch wide, however, in other implementations, each opening of the second plurality of openings may be more or less than about an inch wide.

In the implementations disclosed herein, the second trommel screen 52 is coupled to a motor, which may or may not be the same motor used to rotate the first trommel screen 44. In particular implementations, the second trommel screen may rotate in a direction opposite the direction of rotation of the first trommel screen 44, and may rotate the second trommel screen in any direction, speed, or phase disclosed herein. In other implementations, the second trommel screen 52 may rotate in the same direction as the first trommel screen 44.

In various implementations, the second trommel screen 52, specifically the screens of the second trommel screen 52, may include expanded metal. In such implementations, the expanded metal may include a sharp ridge formed during the expansion of the metal. When the second trommel screen rotates in a first direction, the sharp edge may further break up or grind the material to be screened as the material runs against the sharp edge of the expanded metal. When the second trommel screen 52 rotates in a second direction, the material may not be as affected as the material runs with the sharp edge of the expanded metal. The expanded metal may also increase the structural integrity of the screen as the expanded metal is one single piece. In other implementations, rather than expanded metal, a mesh screen or any other screening device may be used.

Referring back to FIG. 3, one or more sprayer/pressure washer lines may extend within the second stage 54 between the first trommel screen 44 and the second trommel screen 52. In various implementations, the one or more pressure washer lines 72 may be fixedly coupled within the mechanical screening system, meaning that they are not configured to rotate (unlike the trommel screens). In other implementations, the one or more pressure washer lines 72 may be configured to rotate within the second stage 54, and may rotate in sync or out of sync from the first trommel screen 44, the second trommel screen 52, or both the first trommel screen and the second trommel screen. The one or more pressure washer lines 72 may include a plurality of nozzles 74 directed at the plurality of openings 46 in the first trommel screen 44. In particular implementations, the nozzles may be configured to fan out the pressurized fluid. In such implementations, the pressure washer lines may spray the material within the first stage and break up the material to facilitate passage of the material through the plurality of openings 46. Further, the one or more pressure washer lines 72 may prevent the plurality of openings 46 from becoming clogged with material. In various implementations, the one or more pressure washer lines 72 may include three lines that run parallel to the length of the first trommel screen 44 and the second trommel screen 52. In other implementations, the one or more pressure washer lines 72 may include more than three lines or less than three lines. The one or more pressure washer lines may be configured to spray, by non-limiting example, water, air, or any other fluid.

Still referring to FIG. 3, in various implementations the screening portion 10 of the mechanical screening system may include an outer barrel 76 coupled around the second trommel screen 52. As material passes through the second trommel screen 52, it may enter a third stage 78 between the second trommel screen and the outer barrel 76. In various implementations, the outer barrel 76 may have a diameter of two feet, five feet, ten feet, and any diameter less than 10 feet or greater than 2 feet. Referring to FIG. 6, a side view of an outer barrel is illustrated. The outer barrel 76 may be made from a rolled metal or any other durable and strong material. In various implementations, the outer barrel 76 includes a first slot opening 78 and a second slot opening 80. In such an implementation, the material that passes through the first screen 68 may fall on a first portion 82 of the outer barrel and eventually exit the screening portion of the mechanical screening device through slot opening 78. While the first portion 82 is illustrated as being parallel with the second trommel screen, in various implementations the first portion may be angled towards the first slot opening to facilitate passage of the screened material through the first slot opening 78. Similarly, the material that passes through the second screen 70 of the second trommel screen may fall on a second portion 84 of the outer barrel 76 and eventually exit the screening portion of the mechanical screening device through slot opening 80. While the second portion 84 is illustrated as being parallel with the second trommel screen, in various implementations the second portion 84 may be angled towards the second slot opening 80 to facilitate passage of the screened material through the second slot opening. While the first slot opening 78 is illustrated as located at an end of the first portion 82 and the second slot opening 80 is illustrated as located at an end of the second portion 84, in various implementations the slot openings may be located near the middle or near the opposite end of their respective portions. While the implementation of the outer barrel 76 illustrated by FIG. 6 only includes two slot openings, it is understood that the outer barrel may have any number of slot openings, and in particular implementations, may include three slot openings. The number of slot openings may correspond to the number of screens, or pluralities of openings, having different sizes of openings in the second trommel screen. In various implementations, the width of the slot openings may respectively correspond with the width of each opening of the pluralities of openings in the second trommel screen. In other implementations, the slot openings may be wider than the corresponding openings of the pluralities of openings of the second trommel screen 52. In still other implementations, the outer barrel may include openings which are not slot openings, but which still allow the screened material to pass through. Such openings may be any shape, size, and number. In still other implementations, rather than an outer barrel, the screening portion may include a plurality of funnels that sit below the second trommel screen and receive and funnel the screened material according to size. In still other implementations, the material exiting the second trommel screen 52 may not enter into a barrel or funnel, but may be received by a chute, sluice box, or may even just form a pile on a surface. In particular implementations, the slot openings (or other openings) of implementations having a barrel (or a funnel) may be configured to allow material to pass through the slot opening and into a sluice box.

In various implementations, an inner surface of the outer barrel may include one or more ridges or projections that may further break down the material in the third stage 78. In various implementations, the one or more ridges may spiral around the interior of the outer barrel to facilitate movement of material out of the third stage through the slot openings.

In various implementations the outer barrel 76 may include one or more supports 86. The supports 86 may add structural stability to the outer barrel 76, especially in implementations where the outer barrel 76 may be tilted. In various implementations, the outer barrel 76 may include one or more hooks 88 coupled to one or more of the supports 86. The hooks may be configured to allow the outer barrel to be lifted and/or handled for transportation or maintenance.

In the implementations disclosed herein, the outer barrel 76 may be coupled to a motor which rotates the outer barrel 76. The motor may or may not be the same motor used to rotate a trommel screen. In particular implementations, the outer barrel 76 may rotate in a direction opposite the direction of rotation of the first trommel screen 44 and/or the second trommel screen, and may rotate the outer barrel 76 in any direction, speed, or phase disclosed herein. In other implementations, the outer barrel 76 may rotate in the same direction as the first trommel screen 44 and/or the second trommel screen 52, and in particular implementations, the outer barrel 76 may rotate synchronously with respect to the second trommel screen 52.

Referring to FIG. 7, a perspective view of an end of a first trommel screen within a second trommel screen within an outer barrel is illustrated. In particular implementations, the outer barrel 76 may be fixedly coupled to the second trommel screen 52 through one or more arms 90. In such implementations, the rotation and/or movement of the outer barrel 76 may be synchronous with the rotation and/or movement of the second trommel screen. As illustrated by FIG. 7, the first trommel screen 44 may be independent from the second trommel screen while within the second trommel screen. As illustrated by FIG. 7, the one or more pressure washer lines 72 may be independent from the first trommel screen and the second trommel screen and may be fixed within the second trommel screen. In various implementations, the mechanical screening system may not include a second trommel screen but may only include a first stage within the first trommel screen and a second stage between the outer barrel and the first trommel screen. Similarly, in other implementations the mechanical screening system may not include the first trommel screen as described herein but may only include a first stage within a trommel screen similar to the second trommel screen disclosed herein and may include a second stage between the outer barrel and the trommel screen. In still other implementations, a third trommel screen, or any other number of trommel screens, may also be included between the second trommel screen and the outer barrel.

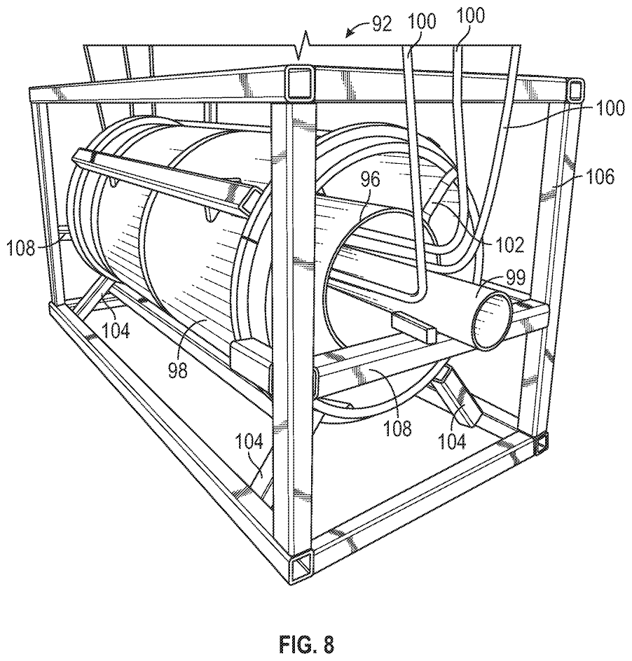

Referring to FIG. 8, a perspective view of a screening portion of a first implementation of a mechanical screening system is illustrated. Similar to the implementations disclosed herein, the screening portion 92 may include a first trommel screen 94 coupled within a second trommel screen 96. The second trommel screen 96 may be coupled within an outer barrel 98. The implementation illustrated in FIG. 8 illustrates how the trommel screens, outer barrel 98, and pressure washer lines 100 are all coupled to a frame 106 while still rotatable in relation to one another. As previously disclosed herein, the second trommel screen 96 may be fixedly coupled to the outer barrel 98 through one or more arms 102. The outer barrel 98 may rest upon a plurality of legs 104. In various implementations, the plurality of legs 104 may support the outer barrel 98 at the ends of the outer barrel, while in other implementations other or the same legs of the plurality of legs may also support the outer barrel 98 between the ends of the outer barrel. The ends of the first trommel screen 94 may extend past the ends of the second trommel screen 96 and the ends of the outer barrel 98 and may rest upon one or more cross bars 108 of the frame 106. The pressure washer lines 100 may be coupled to either an upper portion of the frame 106 or may be part of an exterior system (not shown) which maintains the position of the pressure washer lines 100 within the second trommel screen 96.

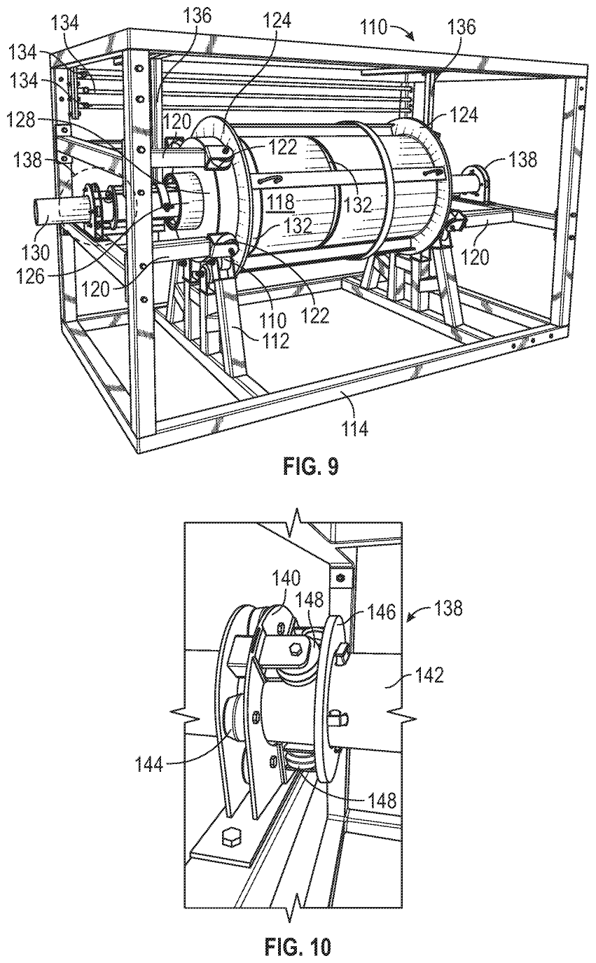

Referring to FIG. 9, a perspective view of a screening portion of a second implementation of a mechanical screening system is illustrated. The general structure of the screening portion 110 may be the same as or similar to the implementations of screening portions herein. As illustrated by FIG. 9, a plurality of legs 112 may be coupled to the frame 114. In various implementations, the plurality of legs 112 may all include rollers 116 at the end of the leg that contact the outer barrel 118. In various implementations, a plurality of end supports 120 may be coupled to the frame 114. The end supports 120 may be perpendicular to the plurality of legs 112. The end supports may be located at both ends of the screening portion 110, or just at a single end of the screening portion. The end supports 120 may have rollers 122 that are configured to come into contact with one or more plates 124 that form a plane perpendicular to the length of the outer barrel 118. In such implementations, the end supports 120 may support the screening portion 110, especially when the screening portion 110 is in an angled position. As illustrated by FIG. 9, the ends of the third stage, or the area between the second trommel screen 126 and the outer barrel 118 may be capped by one or more plates 128 coupled between a first end of the outer barrel and a first end of the second trommel screen, and/or coupled between a second end of the outer barrel and a second end of the second trommel screen. In various implementations, the screening system may be configured to only allow material to leave through an end 130 of the first trommel screen and through one or more slot openings 132 in the outer barrel. In other implementations, the screened material may also be able to leave through an opening at the end of the second trommel screen 126. As illustrated by FIG. 9, one or more pressure washer lines 134 are present, however, they are not shown passing through the second trommel screen in FIG. 9. It is understood that flexible tubing may couple the exterior pressure washer lines 134 to the interior pressure washer lines extending through the second trommel screen. One or more drop down supports 136 may be used to hold the pressure washer lines in place as they extend through the second trommel screen 126.

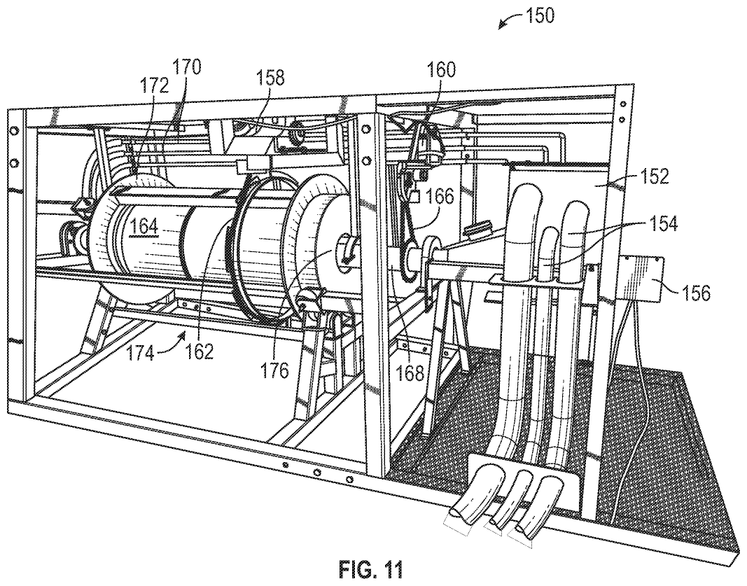

In various implementations, one or more first trommel screen roller supports 138 may be coupled to the frame 114. Referring to FIG. 10, a magnified view of a first trommel screen roller support/bearing assembly of FIG. 9 is illustrated. In various implementations, the first trommel screen roller support or bearing assembly may include a ring 140 through which the first trommel screen 142 passes. The ring 140 may include a plurality of rollers 144 or bearings therein to minimize resistance of the rotating first trommel screen 142. In various implementations, a plate 146 may be fixedly coupled to the first trommel screen 142. A plurality of rollers 148 or bearings may be coupled to the ring 140 and may be configured to roll along a surface of the plate 146. Such rollers 148 or bearings and plates 146 may be especially included when the first trommel screen 142 is configured to operate at an angle.

Referring to FIG. 11, a perspective view of an implementation of a mechanical screening system is illustrated. The implementation of the mechanical screening system 150 illustrated by FIG. 11 may include similar or the same components and subcomponents of any of the mechanical screening systems disclosed herein. As illustrated by FIG. 11, the hopper 152 may be configured to have material pumped into the system through one or more pipes 154. In particular implementations, the system 150 may be configured to screen dredged material. In various implementations, a control box 156 may be coupled to the mechanical screening system 150. The control box 156 may be configured to route power to the various motors of the system and may be configured to allow an operator to control the parameters of the system, such as the tilt, the direction of rotation of the trommel screens, the speed of rotation of the trommel screens, and any other parameter disclosed herein. Such parameters may be changed during operation of the mechanical screening system. In other implementations, the parameters of the system may be controlled via a remote through a wireless or wired connection. In particular implementations, the mechanical screening system may include sensors therein which may communicate with the controller. The controller may automatically operate under particular parameters based upon the information received through the sensors, such as, by non-limiting example, the rate material is passing through the system, whether the screens are becoming overfull, whether the material is wet or dry, the ore grade of the material, the consistency of the material, and any other type of information that can be detected by the sensors.

The mechanical screening system 150 may include a first motor 158 and a second motor 160. The first motor 158 may be configured to rotate the outer barrel 164 through a chain/belt 162 which extends around the outer barrel 164. The outer barrel may include a track or teeth which the chain/belt can run along. Similarly, the second motor may be configured to rotate a first trommel screen 168 through a chain/belt 166 which extends around the first trommel screen 168. Because the first motor is independent from the second motor, the rotation of the outer barrel 164 and the first trommel screen 168 may be independent. In other implementations, the rotation of the outer barrel and the first trommel screen may be powered by a single motor and may be in sync. In other implementations, the rotation of the outer barrel and the first trommel screen may be powered by a single motor but may be out of sync. Specifically, the outer barrel may rotate in a different direction, at a different speed, or in a different phase as compared to the first trommel screen. As illustrated by FIG. 11, in various implementations the one or more pressure washer lines 170 may enter the screening portion 174 through a second end 172 of the screening portion. In other implementations, the one or more pressure washer lines 170 may enter the screening portion through a first end 176 of the screening portion, and in still other implementations the one or more pressure washer lines 170 may enter the screening portion through both the first and the second ends of the screening portions. In implementations with pressure washer lines, a pump may be included in the mechanical screening system which pressurizes the lines. The pressure washer lines of the mechanical screening system may be configured to connect to an outside water source which may be pressurized. In other implementations of mechanical screening systems, no pressure washer lines are included.

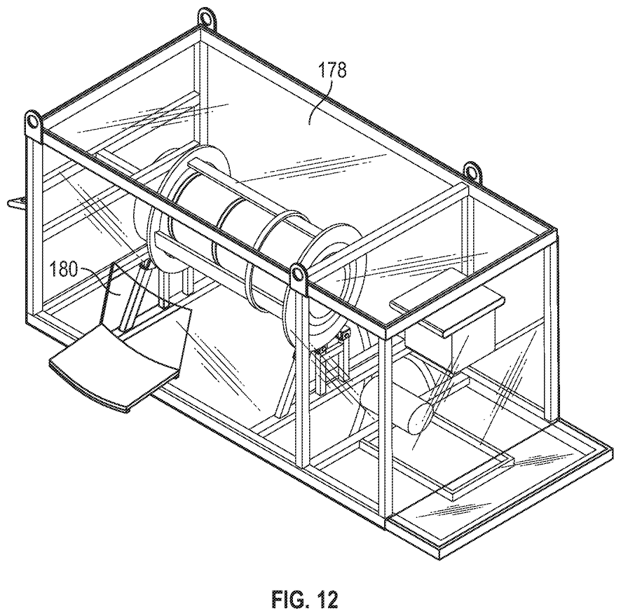

Referring to FIG. 12, a see-through perspective view of a protective box covering a mechanical screening system is illustrated. In various implementations, a protective box 178 or cover may be coupled over any implementations of the mechanical screening system disclosed herein. The protective box may be made of a rigid material such as, by non-limiting example, metal, plastic, or any other rigid and durable material. In particular implementations, the protective box 178 may be at least semi-transparent. In various implementations, the protective box may include one or more openings 180 therein. The openings 180 may be configured to allow screened material to exit the protective screening box. In particular implementations, the one or more openings 180 may be configured to allow a plurality of sluice boxes to pass through the one or more openings. In various implementations, the protective box 178 may be configured to cover the entire mechanical screening system, while in other implementations it may be configured to cover only a portion, such as the screening portion, of the mechanical screening system.

In places where the description above refers to particular implementations of mechanical screenings systems and implementing components, sub-components, methods and sub-methods, it should be readily apparent that a number of modifications may be made without departing from the spirit thereof and that these implementations, implementing components, sub-components, methods and sub-methods may be applied to other mechanical screening systems.

1. A mechanical screening system comprising:
a first trommel screen rotatably coupled within a second trommel screen, the second trommel screen comprising a first plurality of openings and a second plurality of openings, each opening of the first plurality of openings smaller than each opening of the second plurality of openings; and
an outer barrel coupled to the second trommel screen, the outer barrel comprising a first slot opening and a second slot opening therein;
wherein the second trommel screen is rotatable.

2. The screening system of claim 1, wherein the first trommel screen is configured to rotate in a direction opposite a direction the second trommel screen is configured to rotate.

3. The screening system of claim 1, wherein the second trommel screen and the outer barrel are configured to rotate synchronously with respect to each other.

4. The screening system of claim 1, wherein the second trommel comprises expanded metal.

5. The screening system of claim 1, wherein a single motor is configured to rotate the first trommel screen and the second trommel screen.

6. The screening system of claim 1, wherein the screening system is configured to sort material into three different ranges of size.

7. The screening system of claim 1, wherein a width of the first slot opening corresponds to a width of each opening of the first plurality of openings and wherein a width of the second slot opening corresponds to a width of each opening of the second plurality of openings.

8-14. (canceled)

15. A mechanical screening system comprising:
a hopper coupled to a first trommel screen, the first trommel screen configured to rotate;
a second trommel screen rotatably coupled around the first trommel screen, the second trommel screen comprising a first plurality of openings and a second plurality of openings, each opening of the first plurality of openings being smaller than each opening of the second plurality of openings;
an outer barrel rotatably coupled around the second trommel screen, the outer barrel comprising a first and a second opening in a side thereof;
a pressure washer line fixedly coupled between the first trommel screen and the second trommel screen;
a lifting mechanism configured to lift a first end of the screening system while the first trommel screen rotates;
a first motor coupled to and configured to rotate the first trommel screen in a first direction; and
a second motor coupled to and configured to rotate the second trommel screen and the outer barrel in a second direction.

16. The screening system of claim 15, wherein the second trommel screen further comprises a third plurality of openings, wherein each opening of the third plurality of openings is larger than each opening of the second plurality of openings.

17. The screening system of claim 15, wherein the outer barrel further comprises a third opening in the side thereof.

18. The screening system of claim 15, further comprising a first plate coupled between a first end of the outer barrel and a first end of the second trommel screen, and a second plate coupled between a second end of the outer barrel and a second end of the second trommel screen.

19. The screening system of claim 15, wherein the lifting mechanism is configured to lift the first end of the screening system 15 degrees.

20. The screening system of claim 15, further comprising a protective box coupled over the first trommel screen, the second trommel screen, and the outer barrel.
